(19) United States
(12) Patent Application Publication
(10) Pub. No.: US 2024/0368364 A1
(43) Pub. Date: Nov. 7, 2024

(54) AGING-RESISTANT LIGHT-PERMEABLE COMPOSITE MATERIAL FOR VEHICLE TIRES AND PROCESS FOR PRODUCTION THEREOF

(71) Applicant: Continental Reifen Deutschland GmbH, Hannover (DE)

(72) Inventors: Steffen Guitler, Hannover (DE); Mathias Wenckel, Hannover (DE); Rainer Kahner, Arnsberg (DE)

(73) Assignee: Continental Reifen Deutschland GmbH, Hannover (DE)

(21) Appl. No.: 18/688,424

(22) PCT Filed: Aug. 24, 2022
(86) PCT No.: PCT/DE2022/200196

§ 371 Date: Mar. 1, 2024

(30) Foreign Application Priority Data
Sep. 3, 2021 (DE) 10 2021 209 711.1

(51) Int. Cl. C08J 5/24; B60C 1/00; C08J 7/12; C08K 3/36; C08K 5/3437

(52) U.S. Cl. CPC C08J 5/249; B60C 1/0041; C08J 7/12; C08K 3/36; C08K 5/3437; C08J 2323/28

(57) ABSTRACT

A process for producing a vulcanizable composite material, including the steps of: a) producing or providing a textile strength member, b) producing or providing a crosslinkable rubberization mixture comprising: i) at least one base rubber selected from the group consisting of ethylene-propylene-diene rubbers and butyl rubbers, and ii) at least one aging selected from the group consisting of p-phenylenediamines, dihydroquinolines, phenylnaphthylamines, substituted phenols and substituted bisphenols, and c) introducing the textile strength member into the crosslinkable rubberization mixture to obtain the vulcanizable composite material, wherein the crosslinkable rubberization mixture is processible by vulcanization to give a crosslinked rubberization mixture which is at least partly transmissive to visible light at least in sections.

### CROSS-REFERENCE TO RELATED APPLICATIONS

The present application is a National Stage Application under 35 U.S.C. § 371 of International Patent Application No. PCT/DE2022/200196 filed on Aug. 24, 2022, and claims priority from German Patent Application No. 10 2021 209 711.1 filed on Sep. 3, 2021, the disclosures of which are herein incorporated by reference in their entireties.

### TECHNICAL FIELD

The invention relates to a process for producing a vulcanizable composite material and to a process based thereon for producing a vehicle tire, and also to a corresponding vulcanizable composite material and a vulcanized composite material producible therefrom or a corresponding vehicle tire.

### BACKGROUND

It is known that vehicle tires, for example car tires, have textile strength members for reinforcement in various components. In many cases, other industrial rubber articles too, such as belts (including transmission belts) and hoses, have strength members. The strength members here are typically surrounded by at least one rubber mixture which is also referred to as rubberization mixture or, in the vulcanized state, as rubberization.

If permitted by the application-specific demands on the physicochemical properties of the rubberization, for example because the expected demands on a component are such that it is possible, for example, to dispense with the use of carbon black in the rubberization mixture, this rubberization can in principle be made transmissive to light, especially transparent.

As well as the benefits for the design-related configuration of such elastomeric products, especially elevated flexibility for product designers in the design of colorfully appealing designs with interesting depth effects, there has also been increasing focus for some time on the technical benefits enabled by a corresponding transparent configuration for the monitoring of the production process and quality control of the respective products.

While many customers in the case of bicycle tires, for example, find it visually appealing to be able to see the textile strength members in the bicycle tire through a transparent rubberization, the primary factor for the person skilled in the art is that they are able to subject the textile strength members in this configuration to a visual check.

Even though corresponding vulcanized composite materials with transparent rubberization are known from the field of bicycle tires, according to the inventors' assessment, there is no use to date for cars and other motorized vehicles, or at least not in everyday road traffic. One reason for this may be that the physicochemical properties of corresponding transparent rubberizations are frequently considered to be inadequate for use in car tires in order to sufficiently satisfy the expected stresses, which can be attributed in particular to the usually low filler contents.

Even though it seems possible to permit the use of corresponding composite materials in car tires by means of greater control of stress, as permitted, for example, by autonomously driven vehicles, there remains a significant problem with corresponding rubberizations, which is regularly manifested more significantly than in bicycle tires owing to the higher stresses in car tires. This is the propensity of corresponding transmissive rubberizations to exhibit signs of aging, which adversely affect the physicochemical properties of the composite materials with time. The aging mechanisms, aside from aging as a result of mechanical-dynamic stress, include, for example, direct light-induced aging, especially by UV radiation, and aging by the action of oxygen or ozone, which can in turn be formed by the effect of UV radiation.

The corresponding signs of aging are traditionally counteracted by what are called aging stabilizers in the field of tire manufacture. However, many of these aging stabilizers, especially those known as high-performance aging stabilizers, have an undesirable intrinsic color and/or, when used in a transmissive rubberization, lead to corresponding unwanted discoloration, such that there is usually a trade-off between aging resistance and optical properties in the case of transmissive rubberization.

### SUMMARY

The primary object of the present invention was that of eliminating or at least reducing the above-described disadvantages of the prior art.

It was thus an object of the present invention to specify a process for producing vulcanizable composite materials that can be used, by means of vulcanization, to obtain high-performance vulcanized composite materials having excellent optical properties, especially with very substantially colorless or transparent rubberization. One object addressed by the present invention was accordingly for the vulcanized composite materials thus obtained to additionally feature excellent aging resistance, such that physicochemical properties deteriorate to a minimum degree with time.

In this respect, it was an object of the present invention for the vulcanized composite materials thus obtained to enable an improvement in the trade-off between aging resistance, especially with regard to the effect of oxidation and UV radiation, and optical properties.

It was an object of the present invention for the vulcanized composite materials to enable very easy, reliable and in particular nondestructive identification and quality testing of the textile strength members present in the vulcanized composite materials.

It was an additional object of the present invention for the vulcanized composite materials to show sufficiently high bond strength between the textile strength members and the rubberization, and it was also desirable in the light of the above objects for this bond strength to be reduced to a minimum degree with time as a result of environmental effects.

It was a supplementary object of the present invention for the process to be specified to be particularly suitable for the processing of strength members made from recycled polyethylene terephthalate.

It will be clear to the person skilled in the art that it was a supplementary object of the present invention additionally to specify a process for producing a vehicle tire, and a corresponding vehicle tire.

The inventors of the present invention have now found that the above-described objects can be achieved when a crosslinkable rubberization mixture comprising a specific group of rubbers in combination with specific aging stabilizers as defined in the claims is used in the production of corresponding vulcanized composite materials.

The above-stated objects are thus achieved by means of the subject matter of the invention as defined in the claims. Preferred configurations according to the invention will be apparent from the subsidiary claims and from the details that follow.

### DETAILED DESCRIPTION

Embodiments that are referred to below as being preferred are, in particularly preferred embodiments, combined with features of other embodiments that are referred to as being preferred. Combinations of two or more of the embodiments that are described below as being particularly preferred are therefore very particularly preferred. Likewise preferred are embodiments in which a feature of one embodiment that is referred to as being preferred to a certain degree is combined with one or more further features of other embodiments that are referred to as being preferred to a certain degree. Features of preferred vulcanizable composite materials, of vulcanized composite materials, and of vehicle tires will be apparent from the features of preferred processes.

The invention relates to a process for producing a vulcanizable composite material, comprising the steps of:
a) producing or providing a textile strength member,
b) producing or providing a crosslinkable rubberization mixture comprising:
   i) at least one base rubber selected from the group consisting of ethylene-propylene-diene rubbers and butyl rubbers and
   ii) at least one aging stabilizer selected from the group consisting of p-phenylenediamines, dihydroquinolines, phenylnaphthylamines, substituted phenols and substituted bisphenols and
c) introducing the textile strength member into the crosslinkable rubberization mixture to obtain the vulcanizable composite material, wherein the crosslinkable rubberization mixture is processible by vulcanization to give a crosslinked rubberization mixture which is at least partly transmissive to visible light at least in sections.

The process of the invention advantageously affords vulcanizable composite materials from which it is possible to obtain, by means of vulcanization, high-performance vulcanized composite materials having excellent aging resistance and excellent optical properties for use in vehicle tires, especially car tires.

In the vulcanized composite materials obtained, the transmissive rubberization advantageously shows virtually no unwanted discoloration, if any, such that it is advantageously possible to clearly identify even comparatively deep-lying textile strength members from the outside in the vulcanized composite material, such that reliable and nondestructive quality testing is possible, for example even for the customer when buying a tire.

By the process of the invention, it is additionally possible to significantly increase flexibility with regard to color configuration, since the rubberization advantageously does not have any significant intrinsic color, if any, by virtue of the aging stabilizer.

The definition of the crosslinkable rubberization mixture via the properties of the rubberization producible therefrom by vulcanization, i.e. of the crosslinked rubberization mixture, is in accordance with the customary procedure in the art and the understanding of the person skilled in the art, since a corresponding definition in the case of corresponding polymeric materials having a structure that cannot be described exactly is regularly the only practicable way of defining the corresponding material. A vulcanized composite material producible from the vulcanizable composite material accordingly comprises a crosslinked rubberization mixture which is at least partly transmissive to visible light at least in sections.

In the context of the present invention, the expression “at least partly transmissive to visible light”, in accordance with the understanding of the person skilled in the art, means that the crosslinked rubberization mixture shows sufficiently little interaction with electromagnetic radiation of any wavelength in the visible region, or a portion of the wavelengths in the visible region, that the textile strength members in the vulcanizable composite material and in the vulcanized composite material are visible from the outside. This means that it is unnecessary for the crosslinked rubberization mixture to show no absorption at all in the visible wavelength region, since partial absorption, for example at particular wavelengths, can also be tolerated, especially in the case of transparently colored rubberizations.

According to the above definition, the crosslinked rubberization mixture is at least partly transmissive to visible light at least in sections. This means that the vulcanizable composite material or the vulcanized composite material may also include sections in which the rubberization has not been made transmissive, for example in the form of alternating regions or an opaque base beneath the textile strength members that are covered by a transmissive top layer.

The unit “phr” (parts per hundred parts of rubber by weight) used in the context of the present invention is the standard unit of quantity for mixture recipes in the rubber industry. The dosage of the parts by weight of the individual substances is always based here on 100 parts by weight of the total mass of all rubbers present in the mixture, which accordingly adds up to 100.

The process of the invention is advantageously suitable for all textile strength members known to the person skilled in the art. However, the inventors of the present invention were able to identify features of the textile strength member that are particularly suitable for the process of the invention.

To wit, a preferred process of the invention is one wherein the textile strength member is at least partly colored and/or comprises at least one indicator filament, preferably comprises at least one indicator filament. In this configuration, the advantages of the process of the invention are manifested particularly clearly. In the process of the invention, it is additionally also possible to provide air discharge filaments on one or more surfaces of the vulcanizable composite material, which, since they remain visible beneath the transmissive crosslinked rubberization mixture, can advantageously also be colored. Especially in the case of the later positioning of the vulcanized composite materials on the outside of vehicle tires, however, it is preferable not to provide any corresponding air discharge filaments at least on the outer surface.

Preference is additionally given to a process of the invention wherein the textile strength member comprises a material selected from the group consisting of polyesters, polyamides, polyurethanes, glass, carbon, celluloses, polycarbonates, polyketones and combinations of those materials, preferably selected from the group consisting of polyesters, regenerated cellulose, especially rayon, aramids, nylon and combinations of those materials, more preferably selected from the group consisting of nylon, where the textile strength member most preferably consists of those materials. Suitable polyesters include, for example, polyethylene terephthalate (PET), polyethylene naphthalate (PEN), polybutylene terephthalate (PBT), polyethylene furanoate (PEF) and polyester acrylates, which are supplied, for example, by Celanese AG under the Vectran trade name. Examples of polyamides are nylon-4,6 (PA 4.6), nylon-4,10 (PA 4.10), nylon-6 (PA 6), nylon-6,6 (PA 6.6 polyhexamethyleneadipamide), nylon-6,12 (PA 6.12), nylon-10,10 (PA 10.10) and nylon-12, 12 (PA 12.12). Suitable polyamides are, for example, aromatic polyamides such as aramids, especially m-aramid, p-aramid, and mixtures of m-aramid and p-aramid. Suitable celluloses are, for example, regenerated celluloses (especially viscose or rayon) and cellulose esters.

Preference is also given to a process of the invention wherein the textile strength member comprises one or more reinforcement cords, preferably in the form of a weave, in each case comprising at least one yarn. For example, the textile reinforcement material may take the form of single-or multifilament textile cords or take the form of two-dimensional filament fabrics such as fillets based on single-or multifilament yarns. Against this background, preference is given to a process of the invention wherein the textile strength member comprises one or more reinforcement cords, preferably in the form of a weave, in each case comprising at least two different yarns, where the yarns each preferably consist of a material selected from the group consisting of polyesters, polyamides, polyurethanes, glass, carbon, celluloses, polycarbonates and polyketones.

Very particular preference is also given to a process of the invention wherein the textile strength member consists of a recycled material, especially of recycled polyethylene terephthalate.

Preference is fundamentally given to a process of the invention wherein at least one of the yarns, preferably all the yarns, in the reinforcement cords have a linear density in the range from 90 to 5000 dtex, preferably in the range from 100 to 2500 dtex or in the range from 2500 to 4500 dtex, more preferably in the range from 200 to 1500 dtex or in the range from 3000 to 4000 dtex.

Preference is fundamentally also given to a process of the invention wherein at least one of the yarns, preferably all the yarns, in the reinforcement cords have a twist level of 100 to 600 T/m, preferably 150 to 550 T/m, more preferably 200 to 500 T/m.

Preference is fundamentally given additionally to a process of the invention wherein the polyamide yarn has a twist factor in the range from 100 to 400, preferably in the range from 150 to 350. The twist factor a is a parameter known to the person skilled in the art and is calculated from the twist level in T/m (turns per meter) and the linear density in tex:

$$α = T / m \sqrt{\frac{t e x}{1000}}$$

Preference is fundamentally likewise given to a process of the invention wherein at least one of the reinforcement cords, preferably all the reinforcement cords, have two or more yarns, where the yarns in the reinforcement cord have preferably been end-twisted together at 100 to 600 T/m, more preferably at 150 to 550 T/m, most preferably at 200 to 500 T/m.

Preference is fundamentally also given to a process of the invention wherein at least one of the reinforcement cords, preferably all the reinforcement cords, have an overall linear density in the range from 180 to 10 000 dtex, preferably in the range from 200 to 7500 dtex, more preferably in the range from 400 to 5000 dtex.

It will be apparent to the person skilled in the art that it is also possible in the process of the invention to process multiple strength members and incorporate them into a corresponding vulcanizable composite material. For the predominant number of cases, a corresponding process design is actually preferred. Preference is accordingly given to a process of the invention wherein the process is conducted for two or more textile strength members.

The production of vulcanizable rubberization mixtures that result in transmissive, especially transparent, vulcanized rubberization mixtures after vulcanization is known in principle to the person skilled in the art from the prior art, for example from DE 8234954 U1, U.S. Pat. No. 6,624,220 B1 and US 2004/0044118 A1, and so the person skilled in the art can be guided by the prior art in the production.

As described above, it is possible to make merely parts of the rubberization transmissive, for example in that the crosslinkable rubberization mixture consists of two or more rubberization mixture components. Even though it may be preferred specifically in relation to the optical effect, easier manufacture means that preference is given in most cases to rubberizations that are essentially entirely transmissive. Preference is thus given to a process of the invention wherein the crosslinkable rubberization mixture comprises two or more separate rubberization mixture components, wherein at least one rubberization mixture component is processible by vulcanization to give a crosslinked rubberization mixture component which is at least partly transmissive to visible light. Preference is alternatively given to a process of the invention wherein the crosslinkable rubberization mixture is processible by vulcanization to give a crosslinked rubberization mixture which is at least partly transmissive to visible light essentially in its entirety.

With regard to the relevant wavelength ranges in which the rubberization should be transmissive, it is possible to define a suitable range, with particular preference for essentially no diffuse scattering by the rubberization, such that it is transparent. Preference is thus given to a process of the invention wherein the crosslinkable rubberization mixture is processible by vulcanization to give a crosslinked rubberization mixture which is at least partly transmissive to visible light having a wavelength in the range from 380 to 780 nm at least in sections, preferably essentially in its entirety. Preference is likewise given to a process of the invention wherein the crosslinkable rubberization mixture is processible by vulcanization to give a crosslinked rubberization mixture which is at least partly transparent to visible light at least in sections, preferably essentially in its entirety.

The ethylene-propylene-diene rubbers and butyl rubbers that are usable as base rubbers in the process of the invention are known in principle to the person skilled in the art. The expression “butyl rubbers” includes isobutene-isoprene rubbers, which are regularly assigned the abbreviation IIR. IIR is a synthetic rubber which is produced by copolymerization of isobutene and isoprene. In the crosslinkable rubberization mixtures, it is possible to use multiple different isobutene-isoprene rubbers that may differ, for example, in the isoprene content. The butyl rubbers in the context of the present invention also include halogenated isobutene-isoprene rubbers that are likewise known in principle to the person skilled in the art in the field of the rubber industry. These are likewise copolymers of isobutene and isoprene, where the isoprene units in the rubber are at least partly halogenated. In the case of halogenation with chlorine or bromine, the person skilled in the art refers respectively, for example, to chlorobutyl (CIIR) and bromobutyl (BIIR). In the case of butyl rubbers, the proportion of isoprene-derived repeat units is frequently in the range from 1% to 5%, a preferred range being 2% to 4%.

The inventors of the present invention have been able to identify representatives of the rubbers to be used that are particularly suitable for the crosslinkable rubberization mixture. To wit, preference is given to a process of the invention wherein the at least one base rubber is selected from the group consisting of ethylene-propylene-diene rubbers and halogenated butyl rubbers, preferably selected from the group consisting of ethylene-propylene-diene rubbers, chlorinated butyl rubbers and brominated butyl rubbers, more preferably selected from the group consisting of chlorinated butyl rubbers and brominated butyl rubbers.

The crosslinkable rubberization mixture may comprise further rubbers beyond the base rubbers, which is preferable for specific use with regard to the properties of the rubberization that are adjustable thereby. Preference is thus given to a process of the invention wherein the crosslinkable rubberization mixture comprises at least one further diene rubber, where the diene rubber is preferably selected from the group consisting of natural polyisoprene (NR), synthetic polyisoprene (IR), butadiene rubber (BR), styrene-butadiene rubber (SBR), styrene-isoprene rubber, butyl rubber, nitrile rubber (NBR) and chloroprene rubber. For example, the polyisoprene (IR, NR) may either be cis-1,4-polyisoprene or 3,4-polyisoprene. Preference is given, however, to using cis-1,4-polyisoprenes having a cis-1,4 content of >90% by weight. For example, it is possible to obtain such a polyisoprene by stereospecific polymerization in solution with Ziegler-Natta catalysts or using finely divided lithium alkyls. Moreover, natural rubber (NR) is such a cis-1,4-polyisoprene; the cis-1,4 content in natural rubber is greater than 99% by weight. The polybutadiene (BR) may, for example, be cis-1,4-polybutadiene or vinylpolybutadiene (vinyl content about 10% to 90% by weight). Preference is given to using cis-1,4-polybutadiene with a cis-1,4 content greater than 90% by weight, which can be prepared, for example, by solution polymerization in the presence of catalysts of the rare earth type. The styrene-butadiene copolymers (SBR) may, for example, be solution-polymerized styrene-butadiene copolymers (S-SBR) having a styrene content, based on the polymer, of about 10% to 45% by weight and a vinyl content (i.e. content of 1,2-bonded butadiene, based on the overall polymer) of 10% to 70% by weight, which can be prepared, for example, using lithium alkyls in organic solvents. The S-SBR may also be coupled and endgroup-modified. Alternatively, it is possible to use emulsion-polymerized styrene-butadiene copolymers (E-SBR) and mixtures of E-SBR and S-SBR. The styrene content of the E-SBR is about 15% to 50% by weight, and it is possible to use, for example, the products known from the prior art that have been obtained by copolymerization of styrene and 1,3-butadiene in aqueous emulsion.

For the base rubbers, according to the inventors' assessment, however, it is possible to specify preferred contents in the presence of further diene rubbers. To wit, preference is given to a process of the invention wherein the crosslinkable rubberization mixture comprises base rubber in a total amount of 10 phr or more, preferably of 20 phr or more, more preferably of 35 phr or more, most preferably of 50 phr or more, or wherein the crosslinkable rubberization mixture comprises base rubber in a total amount in the range from 10 to 90 phr, preferably in the range from 20 to 75 phr, more preferably in the range from 35 to 65 phr, most preferably in the range from 50 to 60 phr.

The inventors of the present invention have been able to identify representatives of the aging stabilizers to be used that are particularly suitable for the crosslinkable rubberization mixture. To wit, preference is given to a process of the invention wherein the at least one aging stabilizer is selected from the group consisting of p-phenylenediamines, dihydroquinolines and phenylnaphthylamines, preferably selected from the group consisting of p-phenylenediamines and dihydroquinolines, more preferably selected from the group consisting of dihydroquinolines.

Additionally or alternatively, preference is given to a process of the invention wherein the at least one ageing stabilizer is selected from the group consisting of N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), N,N′-bis(1,4-dimethylpentyl)-p-phenylenediamine (77PD), 2-N,4-N,6-N-tris[4-(5-methylhexan-2-ylamino)phenyl]-1,3,5-triazine-2,4,6-triamine (PPD triazine), poly-2,2,4-trimethyl-1,2-dihydroquinoline (TMQ), N-phenyl-1-naphthylamine (PAN), 2,2′-methylenebis(4-methyl-6-tert-butylphenol) (BKF), butylhydroxytoluene (BHT), poly (dicyclopentadiene-co-p-cresol), styrenated phenol (SAPH) and 1,3-dihydro-4-methyl-2H-benzimidazole-2-thione (MMBI), preferably selected from the group consisting of 2-N,4-N,6-N-tris[4-(5-methylhexan-2-ylamino)phenyl]-1,3,5-triazine-2,4,6-triamine (PPD triazine), poly-2,2,4-trimethyl-1,2-dihydroquinoline (TMQ), N-phenyl-1-naphthylamine (PAN) and 2,2′-methylenebis(4-methyl-6-tert-butylphenol) (BKF), more preferably poly-2,2,4-trimethyl-1,2-dihydroquinoline (TMQ).

The inventors also suggest proportions by mass for the content of the specific aging stabilizers with which it is possible to obtain particularly advantageous properties, especially low intrinsic color with simultaneously good aging characteristics of the vulcanized composite materials. To wit, preference is given to a process of the invention wherein the crosslinkable rubberization mixture comprises the aging stabilizer(s) in a total amount in the range from 0.1 to 10 phr, preferably in the range from 0.5 to 8 phr, more preferably in the range from 1 to 6 phr, most preferably in the range from 2 to 4 phr.

Particular preference is also given to a process of the invention wherein the crosslinkable rubberization mixture comprises two or more, preferably three or more, more preferably four or more, of the specific aging stabilizers.

Preference is also given to a process of the invention wherein the crosslinkable rubberization mixture comprises 10 to 90 phr, preferably 15 to 40 phr, of a filler, preferably amorphous silicon dioxide, especially precipitated silica, where the crosslinkable rubberization mixture most preferably comprises a polar filler, especially amorphous silicon dioxide, and one or more silane compounds for binding of the polar fillers. The filler may be any suitable material known in the prior art for use as a filler, or a mixture of these materials. The rubberization mixture preferably comprises silica as filler, which is referred to in the specialist field as amorphous silicon dioxide. This may comprise customary silicas for tire rubber mixtures. It is particularly preferable when a finely divided, precipitated silica is used, having a CTAB surface area (to ASTM D 3765) of 30 to 350 m²/g, preferably of 120 to 250 m²/g. Silicas used may, for example, be either conventional silicas, such as those of the VN3 type (trade name) from Evonik, or highly dispersible silicas known as HD silicas (e.g. Ultrasil 7000 from Evonik).

For some applications, preference is given to a process of the invention wherein the crosslinkable rubberization mixture additionally comprises 0.1 to 10 phr of further fillers, where the further fillers are selected from the group consisting of aluminosilicates, chalk, starch, magnesium oxide, titanium dioxide, rubber gels and combinations of these fillers. Preference is alternatively given to a process of the invention wherein the crosslinkable rubberization mixture comprises less than 0.005 phr, preferably less than 0.001 phr, of the further fillers.

In order to obtain filler-containing transmissive rubberizations, it is regularly productive to minimize the content of black pigments and other colorants. Preference is therefore given to a process of the invention wherein the crosslinkable rubberization mixture comprises less than 1 phr, preferably less than 0.1 phr, more preferably less than 0.01 phr, of black colorants, especially black pigments, especially carbon black, graphene or carbon nanotubes, as filler.

Preference is also given to a process of the invention wherein the crosslinkable rubberization mixture comprises 1 to 5 phr, preferably 2 to 4 phr, of zinc carbonate.

The vulcanization of the crosslinkable rubberization mixture is regularly performed in the presence of sulfur and/or sulfur donors, and some sulfur donors can simultaneously act as vulcanization accelerators. Sulfur or sulfur donors are added to the rubberization mixture in the last mixing step in the amounts that are commonly used by the person skilled in the art (0.4 to 8 phr, sulfur preferably in amounts of 0.4 to 4 phr). The vulcanization can also be effected in the presence of very small amounts of sulfur in combination with sulfur donor substances. In addition, the rubberization mixture may comprise vulcanization-influencing substances such as vulcanization accelerators, vulcanization retardants and vulcanization activators in customary amounts, in order to control the time required and/or the temperature required in the vulcanization and to improve the vulcanizate properties. The vulcanization accelerators may, for example, be selected from the following groups of accelerators: thiazole accelerators, for example 2-mercaptobenzothiazole, sulfenamide accelerators, for example benzothiazyl-2-cyclohexylsulfenamide (CBS), guanidine accelerators, for example N,N′-diphenylguanidine (DPG), dithiocarbamate accelerators, for example zinc dibenzyldithiocarbamate, disulfides, thiophosphates. The accelerators can also be used in combination with one another, which can give rise to synergistic effects. Against this background, preference is given to a process of the invention wherein the crosslinkable rubberization mixture comprises 0.4 to 8.0 phr, preferably 0.4 to 4 phr, more preferably 0.5 to 2.5 phr, of sulfur, where the crosslinkable rubberization mixture preferably comprises one or more further vulcanization additives selected from the group consisting of vulcanization accelerators, vulcanization retardants and vulcanization activators.

Preference is additionally given to a process of the invention wherein the crosslinkable rubberization mixture comprises one or more additives selected from the group consisting of coupling agents, especially silane coupling agents, plasticizers, activators, waxes, tackifying resins, mastication aids and processing aids. Useful plasticizers include all plasticizers known to those skilled in the art, for example aromatic, naphthenic or paraffinic mineral oil plasticizers, for example MES (mild extraction solvate) or TDAE (treated distillate aromatic extract), or rubber-to-liquid oils (RTL) or gas-to-liquid oils (GTL) or biomass-to-liquid oils (BTL; as disclosed, for example, in DE 10 2008 037 714 A1) or oils based on renewable raw materials, for example rapeseed oil, terpene oils (e.g. orange oils) or factices or plasticizer resins or liquid polymers (such as liquid BR), the average molecular weight of which (determined by GPC=gel permeation chromatography, using a method based on BS ISO 11344:2004) is in the range from 500 to 20 000 g/mol. If liquid polymers are used as plasticizers in the rubberization mixture, these are not counted as rubber in the calculation of the composition of the polymer matrix (phr calculation). When mineral oil is used, particular preference is given to white oils. Activators used are, for example, zinc oxide and fatty acids (e.g. stearic acid). One example of a mastication aid is, for example, 2,2′-dibenzamidodiphenyl disulfide (DBD). The processing aids include, for instance, fatty acid salts, for example zinc soaps, and fatty acid esters and derivatives thereof, for example PEG carboxylates.

In a particularly preferred embodiment, the crosslinkable rubberization mixture comprises one or more light stabilizer waxes, preferably in a proportion of 1 to 3 phr, more preferably in a proportion of 1.5 to 2.5 phr, most preferably in a proportion of 1.8 to 2.2 phr.

Particularly pleasing visual effects can be created when the crosslinkable rubberization mixture is colored and transmissive, especially colored and transparent, i.e. shows nonuniform absorption characteristics in the visible spectrum, which can be achieved by dyes. Preference is therefore given to a process of the invention wherein the crosslinkable rubberization mixture comprises one or more dyes.

For optimization of the properties of the vulcanizable composite materials producible by the process of the invention, it has been found to be advantageous additionally to provide a coating of the textile strength members or of the weave produced therefrom, which can be effected productively in the course of a hot stretching operation. Preference is accordingly given to a process of the invention additionally comprising, prior to step c), process step c0):
c0) coating the textile strength member with a coating substance,
wherein the coating of the textile strength member preferably includes hot stretching of the textile strength member and/or wherein the coating substance is preferably selected from the group consisting of adhesive impregnations, more preferably selected from the group consisting of RFL dips comprising resorcinol, formaldehyde and latex, and aqueous dispersions, wherein the aqueous dispersions are essentially free of free resorcinol and resorcinol precondensates, especially resorcinol-formaldehyde precondensates, and are free of free formaldehyde and formaldehyde-releasing substances.

The vulcanizable composite materials produced by the process of the invention can be separately vulcanized or installed in vehicle tire blanks, for example in blanks for bicycle tires, and then converted by vulcanization to corresponding vehicle tires comprising the advantageous vulcanized composite material. The invention therefore also relates to a process for producing a vehicle tire, comprising the steps of the process of the invention for producing a vulcanizable composite material, and additionally the steps of:
d) producing an unvulcanized vehicle tire blank comprising the vulcanizable composite material, and
e) vulcanizing the unvulcanized vehicle tire blank to obtain a vehicle tire.

Preference is given in this respect to a process of the invention wherein the vehicle tire is a car tire comprising the vulcanized composite material as part of the carcass, preferably in the region of the sidewall, wherein the vulcanized composite material is preferably additionally covered at least in sections by a vulcanized rubber mixture which is at least partly transmissive to visible light.

In the light of the above details, it will be apparent to the person skilled in the art that the invention also relates to the vulcanizable composite material produced by the process of the invention, to the vulcanized composite material producible therefrom and to the corresponding vehicle tires, respectively resulting in the benefits discussed above.

The invention thus also relates to a vulcanizable composite material for the production of vehicle tires, comprising:
x) at least one textile strength member, and
y) a crosslinkable rubberization mixture surrounding the strength member, comprising:
   i) at least one base rubber selected from the group consisting of ethylene-propylene-diene rubbers and butyl rubbers and
   ii) at least one aging stabilizer selected from the group consisting of p-phenylenediamines, dihydroquinolines, phenylnaphthylamines, substituted phenols and substituted bisphenols,
wherein the crosslinkable rubberization mixture is processible by vulcanization to give a crosslinked rubberization mixture which is at least partly transmissive to visible light at least in sections.

The invention consequently likewise relates to a vulcanized composite material produced or producible by vulcanization of the vulcanizable composite material of the invention, comprising a crosslinked rubberization mixture which is at least partly transmissive to visible light.

The invention likewise relates to a vehicle tire comprising a vulcanized composite material of the invention, preferably produced or producible by the process of the invention for production of a vehicle tire.

Preference is given in this respect to a vehicle tire, preferably a car tire, comprising the vulcanized composite material as part of the carcass, preferably in the region of the sidewall, wherein the vulcanized composite material is additionally covered at least in sections by a vulcanized rubber mixture which is at least partly transmissive to visible light.

Proposed hereinafter is an illustrative configuration of the process of the invention, which, in the view of the inventors, is a particularly advantageous configuration. Moreover, an inventive car tire produced by this illustrative process is proposed, which, in the view of the inventors, is likewise a particularly favorable embodiment of a vehicle tire of the invention in which the benefits of the present invention are manifested particularly clearly.

In the course of the illustrative process, a textile strength member is provided, which is a weave composed of multiple reinforcement cords, wherein the reinforcement cords each comprise multiple PET yarns made of recycled PET. The textile strength member is adhesion-activated with a customary RFL dip by a dipping method and processed by hot stretching. Subsequently, the textile strength member is fully embedded into a crosslinkable rubberization mixture.

The crosslinkable rubberization mixture here comprises 55 phr NR, 20 phr BR, and as base rubber 25 phr BIIR. The crosslinkable rubberization mixture additionally comprises 2 phr of TMQ. The crosslinkable rubberization mixture additionally comprises 25 phr of amorphous silicon dioxide as filler and is free of black colorants, especially black pigments such as carbon black or graphene. As part of a customary vulcanization system, the crosslinkable rubberization mixture additionally comprises 3 phr of sulfur, and additionally customary further constituents such as plasticizers (about 15.5 phr), tackifying resins (about 2 phr), activators (about 5 phr) and crosslinkers (about 1.4 phr), where these are selected such that they do not impair the transparency of the crosslinked rubberization mixture. This crosslinkable rubberization mixture results, after the vulcanization, in a crosslinked rubberization mixture which, in its entirety, is transmissive to visible light having wavelengths in the range from 380 to 780 nm, such that the strength members embedded in the transparent crosslinked rubberization mixture are readily apparent from the outside to the naked eye.

The vulcanizable composite material produced as described above, as part of the tire carcass, is assembled together with other components to give an unvulcanized vehicle tire blank, where the vulcanizable composite material in the side region of the vehicle tire blank is exposed and not covered with an additional sidewall. Subsequently, vulcanization of the unvulcanized vehicle tire blank under customary conditions affords a car tire comprising, in the sidewall region, the vulcanized composite material that forms the outermost layer of the car tire, such that the textile strength members are visible, and the vulcanized composite material advantageously has excellent aging resistance.

1-10. (canceled)

11. A process for producing a vulcanizable composite material, comprising the steps of:
a) producing or providing a textile strength member,
b) producing or providing a crosslinkable rubberization mixture comprising:
i) at least one base rubber selected from the group consisting of ethylene-propylene-diene rubbers and butyl rubbers and
ii) at least one aging stabilizer selected from the group consisting of p-phenylenediamines, dihydroquinolines, phenylnaphthylamines, substituted phenols and substituted bisphenols and
c) introducing the textile strength member into the crosslinkable rubberization mixture to obtain the vulcanizable composite material,
wherein the crosslinkable rubberization mixture is processible by vulcanization to give a crosslinked rubberization mixture which is at least partly transmissive to visible light at least in sections.

12. The process as claimed in claim 11, wherein the at least one base rubber is selected from the group consisting of ethylene-propylene-diene rubbers and halogenated butyl rubbers.

13. The process as claimed in claim 11, wherein the at least one base rubber is selected from the group consisting of ethylene-propylene-diene rubbers, chlorinated butyl rubbers and brominated butyl rubbers.

14. The process as claimed in claim 11, wherein the at least one base rubber is selected from the group consisting of chlorinated butyl rubbers and brominated butyl rubbers.

15. The process as claimed in claim 11, wherein the crosslinkable rubberization mixture comprises the base rubber in a total amount of 10 phr or more, preferably of 20 phr or more, more preferably of 35 phr or more, most preferably of 50 phr or more, or wherein the crosslinkable rubberization mixture comprises base rubber in a total amount in the range from 10 to 90 phr, preferably in the range from 20 to 75 phr, more preferably in the range from 35 to 65 phr, most preferably in the range from 50 to 60 phr.

16. The process as claimed in claim 11, wherein the at least one aging stabilizer is selected from the group consisting of p-phenylenediamines, dihydroquinolines and phenylnaphthylamines.

17. The process as claimed in claim 11, wherein the at least one aging stabilizer is selected from the group consisting of p-phenylenediamines and dihydroquinolines.

18. The process as claimed in claim 11, wherein the at least one aging stabilizer is a dihydroquinoline.

19. The process as claimed in claim 11, wherein the at least one aging stabilizer is selected from the group consisting of N-phenyl-N′-(1,3-dimethylbutyl)-p-phenylenediamine, N,N′-diphenyl-p-phenylenediamine, N,N′-ditolyl-p-phenylenediamine, N-isopropyl-N′-phenyl-p-phenylenediamine, N,N′-bis(1,4-dimethylpentyl)-p-phenylenediamine, 2-N,4-N,6-N-tris[4-(5-methylhexan-2-ylamino)phenyl]-1,3,5-triazine-2,4,6-triamine, poly-2,2,4-trimethyl-1,2-dihydroquinoline, N-phenyl-1-naphthylamine, 2,2′-methylenebis(4-methyl-6-tert-butylphenol), butylhydroxytoluene, poly(dicyclopentadiene-co-p-cresol), styrenated phenol and 1,3-dihydro-4-methyl-2H-benzimidazole-2-thione.

20. The process as claimed in claim 11, wherein the at least one aging stabilizer is selected from the group consisting of 2-N,4-N,6-N-tris[4-(5-methylhexan-2-ylamino)phenyl]-1,3,5-triazine-2,4,6-triamine, poly-2,2,4-trimethyl-1,2-dihydroquinoline, N-phenyl-1-naphthylamine and 2,2′-methylenebis(4-methyl-6-tert-butylphenol).

21. The process as claimed in claim 11, wherein the at least one aging stabilizer is poly-2,2,4-trimethyl-1,2-dihydroquinoline.

22. The process as claimed in claim 11, wherein the crosslinkable rubberization mixture comprises the aging stabilizer in a total amount in the range from 0.1 to 10 phr.

23. The process as claimed in claim 11, wherein the crosslinkable rubberization mixture comprises the aging stabilizer in a total amount in the range from 0.5 to 8 phr.

24. The process as claimed in claim 11, wherein the crosslinkable rubberization mixture comprises the aging stabilizer in a total amount in the range from 1 to 6 phr.

25. The process as claimed in claim 11, wherein the crosslinkable rubberization mixture comprises the aging stabilizer in a total amount in the range from 2 to 4 phr.

26. The process as claimed in claim 11, wherein the crosslinkable rubberization mixture comprises 10 to 90 phr, preferably 15 to 40 phr, of amorphous silicon dioxide.

27. A process for producing a vehicle tire, comprising the steps of the process as claimed in claim 11, and additionally the steps of
d) producing an unvulcanized vehicle tire blank comprising the vulcanizable composite material, and
e) vulcanizing the unvulcanized vehicle tire blank to obtain a vehicle tire.

28. A vulcanizable composite material for the production of vehicle tires, comprising:
at least one textile strength member, and
a crosslinkable rubberization mixture surrounding the strength member, comprising:
i) at least one base rubber selected from the group consisting of ethylene-propylene-diene rubbers and butyl rubbers and
ii) at least one aging stabilizer selected from the group consisting of p-phenylenediamines, dihydroquinolines, phenylnaphthylamines, substituted phenols and substituted bisphenols,
wherein the crosslinkable rubberization mixture is processible by vulcanization to give a crosslinked rubberization mixture which is at least partly transmissive to visible light at least in sections.

29. A vulcanized composite material produced or producible by vulcanization of the vulcanizable composite material as claimed in claim 28, comprising a crosslinked rubberization mixture which is at least partly transmissive to visible light.

30. A vehicle tire comprising a vulcanized composite material as claimed in claim 29.
